(19) United States
(12) Patent Application Publication
(10) Pub. No.: US 2006/0221959 A1
(43) Pub. Date: Oct. 5, 2006

(54) Data compression device and method, and program for data compression

(75) Inventor: Yasuaki Sumiyoshi, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: NEC Corporation

(21) Appl. No.: 11/391,314

(22) Filed: Mar. 29, 2006

(30) Foreign Application Priority Data
Mar. 29, 2005 (JP) 2005-096222

(51) Int. Cl. H04L 12/56; H04J 3/22

(52) U.S. Cl. 370/389; 370/465

(57) ABSTRACT

To perform effective compression while maintaining the quality of the data, there is provided a data compression device for compressing a prescribed data file, which comprises: a compression threshold value storage device for storing a compression threshold value indicating compression limit that is set in advance in accordance with a prescribed property of the data file; and a compression device for compressing the data file based on the compression threshold value stored in the compression threshold value storage device.

### BACKGROUND OF THE INVENTION

1. Field of the Invention

The present invention relates to a data compression device and, more particularly, to a data compression device that compresses a data file and transmits it to a terminal.

2. Description of the Related Art

In accordance with improvements in network technology and spread of personal computers and portable telephones in recent years, data communication between terminals, particularly, data communication using electronic mails is performed ordinarily. In an electronic mail, not only text data such as the mail main text but also various forms of files such as an image, voice, and video file can be attached for transmitting those files to a receiver terminal.

However, if the number of attached files is great and the capacity is large, there requires tremendous communication time and communication cost, which may impose excessive load on the network, server, and the receiver terminal as well. Further, it may cause such a shortcoming that other important electronic mails cannot be received because of receiving such large-capacity electronic mail. Thus, it is common to set an upper limit value for the data size of file that can be received through an electronic mail. Particularly, in a portable telephone, memory capacity of the telephone itself is very small, so that the capacity of an electronic mail that can be transmitted/received is limited to be extremely small.

Because of these reasons, it has been investigated to reducing the data capacity of the file itself to be transmitted/received at the time of communication. Such technique is disclosed in following Patent Literatures. Patent Literature 1 discloses a technique which, when data size of an electronic mail exceeds a prescribed upper limit value, reduces the data size by compressing or deleting image data that is attached to the electronic mail so that it does not exceed the upper limit value. Further, in the case where there is a limit in the transmittable capacity of an electronic mail per transmission, it is possible to transmit the electronic mail by dividing it into a plurality of times of transmissions. Patent literature 2 discloses such technique.

Furthermore, even though it is possible to attach various kinds of files as described above, a receiver terminal may not be compatible with the formats of the attached files. Particularly, in the portable telephones, there are those types that are not provided with a function of displaying a prescribed format image file. For dealing with such case, following Patent Literature 3 discloses a technique which checks the type of the transmission-target terminal, and converts the image file into a format that can be displayed in that terminal. With this format conversion, compression of the file may be carried out. Thereby, it is possible to decrease the data size while allowing the file to be converted into the format that can be used in the receiver side.

It has been investigated to perform smooth data communication such as transmission/reception of electronic mails, to which various kinds of files are attached, in the manner as described above.

[Patent Literature 1] Japanese Patent Unexamined Publication 2003-281063

[Patent Literature 2] Japanese Patent Unexamined Publication 2004-140478

[Patent Literature 3] Japanese Patent Unexamined Publication 2005-33659

However, there are following shortcomings in the above-described conventional cases. First, in the case where there is set an upper limit value of the data size to be transferred and the file is deleted or compressed to be within the upper limit value, it is possible that the file which is important to the receiver side is deleted or the degree of the file compression is too much so that the file becomes unusable. Thus, it may cause such inconvenience for the receiver side that the contents of the file cannot be checked. Particularly, when an image file is attached to an electronic mail transmitted between portable telephones, the image data needs to be compress-processed at a high compression rate for satisfying the upper limit value of the transferable data size through the portable telephones since it is set as extremely low. With this, it is possible that the image data is compressed to such an extent that the user cannot check the contents of the image data. As the number of attached files increases, the capacity per file is limited lower. Thus, the above-described inconvenience becomes prominent when it is the data in a format which cannot bear high compression.

As described above, it is possible to perform transmission by dividing the electronic mail data. However, by transmitting the data in a plurality of times, there may increase processing load on the terminal and, in addition, increase load of operation for the user. Furthermore, since the total data size is not reduced, it is difficult to reduce the network load and the communication cost.

### SUMMARY OF THE INVENTION

The object of the present invention therefore is to perform effective compression while maintaining the quality of data.

Therefore, the data compression device according to one form of the present invention is a data compression device for compressing a prescribed data file, which comprises: a compression threshold value storage device for storing a compression threshold value indicating compression limit that is set in advance in accordance with a prescribed property of the data file; and a compression device for compressing the data file based on the compression threshold value stored in the compression threshold value storage device.

At this time, the compression device performs compression such that the prescribed property of the data file does not become less than the compression threshold value. Further, the compression threshold value is a value that is set to maintain the quality of the data file at a prescribed level. Furthermore, the compression threshold value is a value that is set to maintain the picture-quality of the data file at a prescribed level when the data file is the image data. Moreover, the compression threshold value is a capacity value of the data file.

In the above-described invention, first, the compression threshold values indicating the compression limits for the properties of the data file, e.g. capacity values, color information of the image data, are set and stored in advance. The compression threshold values are the values that are set to maintain the quality of the data file at a prescribed level, for example. The data compression device performs compression based on the compression threshold value of the data file so as not be lower than the compression threshold value, for example. Thus, the data file is compressed while maintaining the quality. Therefore, it is possible in the terminal to receive the data file of low capacity and with less quality deterioration through performing transmission to a prescribed terminal by the data transmission device. For example, it can be used as a mail server assuming that the data file is an electronic mail.

Further, the compression threshold value is a value set for each format of the data file; and the compression device performs compression on the data file in accordance with the compression threshold value that is set for the same format as the format of the data file.

Thereby, the data file compression processing is performed in accordance with the compression threshold values set for each format. Thus, the compression processing in accordance with the properties of individual data files is executed, thereby achieving compressing with still smaller quality deterioration.

Further, the data compression device comprises a data transmission device for transmitting the data file as transmission data, which is compressed by the compression device, to a terminal connected through a network. It is provided with a receiving capacity upper limit value storage device that stores the receiving capacity upper limit value for the terminal as the transmission target of the transmission data, and the compression device performs compression such that capacity of the transmission data fits within the receiving capacity upper limit value.

With this, it is compressed to have the capacity that can be received by the terminal as the transmission target while maintaining the quality of the data file as described above. Therefore, the terminal side can receive the data file more surely.

Furthermore, the transmission data contains a plurality of data files. Moreover, the data compression device comprises a compression upper limit value allotting device for allotting the receiving capacity upper limit value as compression upper limit values for each data file; and the compression device performs compression such that the capacities of the respective data files become lower than the allotted compression upper limit values. At this time, the compression upper limit value allotting device allots the compression upper limit value in accordance with the compression threshold values that are set according to the formats of the respective data files. Further, the compression upper limit value allotting device allots the compression upper limit value in accordance with ratio of each compression threshold value of each format of the respective data files.

With this, it is possible to perform data transmission by carrying out compression while maintaining the quality even for the transmission data containing a plurality of data files. In that case, the receiving capacity upper limit value is allotted for the capacities to be used for each data file, and compression is performed such that each data file fits within the respective compression upper limit value. Thus, it is possible to execute the compression processing on each data file in parallel so as to be fitted within the respective compression upper limit values, thereby achieving speedup of the processing. Particularly, by allotting the compression upper limit values in accordance with the ratio of the compression threshold values of each data file, the qualities of each data file can be made uniform.

Further, the data compression device comprises: a format information storage device for storing format information indicating usable or unusable format for the terminal as the transmission target of the transmission data; and; a file deleting device for deleting the data file of the unusable format based on the format information in the format information storage device.

Similarly, the data compression device comprises: the format information storage device for storing the format information indicating usable or unusable format for the terminal as the transmission target of the transmission data; and a format conversion device for converting the data file of the unusable format into the usable format based on the format information in the format information storage device.

Furthermore, the data compression device comprises: a file number storage device for storing the number of files that can be received in a terminal as a transmission target of transmission data; and a file number deleting device for deleting a prescribed data file from the transmission data so that data file number contained in the transmission data falls within the file number stored in the file number storage device.

At this time, the data compression device comprises a deletion priority order information storage device for storing pre-set deletion priority order information of the data files; and the file number deleting device deletes the data files based on the deletion priority order information.

With this, the information such as the receivable data file in the terminal as the transmission target and the data file number are stored in advance. Based on this, the non-receivable or unusable data file for the terminal is deleted. Therefore, capacity of the transmission data can be effectively decreased. Moreover, by performing the compression processing under such state, speedup of the processing can be achieved.

Furthermore, a data compression program as another form of the present invention employs a constitution that allows a computer for compressing a prescribed data file to achieve a compression device which reads out, from a compression threshold value storage device, a compression threshold value set in advance indicating compression limit for a prescribed property of the data file, and compresses the data file in accordance with the compression threshold value.

Further, the compression threshold value is a value set for each format of the data file; and the compression device performs compression on the data file in accordance with the compression threshold value that is set for the same format as the format of the data file.

Furthermore, the data compression program allows the computer to achieve a data transmission device that transmits, as transmission data, the data file compressed by the compression device to a terminal connected through a network, and the compression device reads out, from the receiving capacity upper limit value storage device, the receiving capacity upper limit value of the terminal as the transmission target of the transmission data, and performs compression such that capacity of the transmission data fits within the receiving capacity upper limit value.

Moreover, the data compression program allows the computer to achieve a compression upper limit value allotting device for allotting the receiving capacity upper limit value as compression upper limit values for each of a plurality of data files; and the compression device performs compression such that the capacities of the respective data files become lower than the allotted compression upper limit values.

Further, the data compression program employs a constitution that allows the computer to achieve a file deleting device which reads out, from a format information storage device, format information indicating usable or unusable format for the terminal as the transmission target of the transmission data, and deletes the data file of the unusable format based on the format information.

Furthermore, the data compression program employs a constitution that allows the computer to achieve a format conversion device which reads out, from the format information storage device, format information indicating usable or unusable format for the terminal as the transmission target of the transmission data, and converts the data file of the unusable format into the usable format based on the format information.

Moreover, the data compression program employs a constitution that allows the computer to achieve a file number deleting device which reads out, from a file number storage device, the file number that can be received in the terminal as the transmission target of the transmission data, and deletes a prescribed data file from the transmission data such that data file number contained in the transmission data falls within the file number.

Further, a data compression method as still another form of the present invention is a data transmission method which compresses a prescribed data file using a computer, wherein the computer reads out, from a compression threshold value storage device, a compression threshold value set in advance indicating compression limit for a prescribed property of the data file, and compresses the data file in accordance with the compression threshold value.

At this time, the compression threshold value is a value set for each format of the data file and, at the time of compression, the computer performs compression on the data file in accordance with the compression threshold value that is set for the same format as the format of the data file.

Furthermore, the computer: after compression, transmits the compressed data file as the transmission data to a terminal connected through a network; before compression, reads out, from the receiving capacity upper limit value storage device, the receiving capacity upper limit value for the terminal as the transmission target of the transmission data; and at the time of compression, compresses the data file such that the capacity of the transmission data fits within the receiving capacity upper limit value.

Furthermore, the computer: before compression, allots the receiving capacity upper limit value as the compression upper limit values of each data file; and at the time of compression, compresses the data file such that the capacities each data file become less than the allotted compression upper limit values.

Moreover, the computer: before compression, reads out, from the format information storage device, format information indicating usable or unusable format for the terminal as the transmission target of the transmission data; and deletes the data file of the unusable format based on the format information.

Further, the computer: before compression, reads out, from the format information storage device, format information indicating usable or unusable format for the terminal as the transmission target of the transmission data; and converts the data file of the unusable format into the usable format based on the format information.

Furthermore, the computer: before compression, reads out, from the file number storage device, the file number that can be received in the terminal as the transmission target of the transmission data; and deletes a prescribed data file from the transmission data such that data file number contained in the transmission data falls within the file number.

The program and method in the above-described constitutions also function like the above-described data compression device, so that the aforementioned object of the present invention can also be achieved.

The present invention is structured and functions as described above. With this, it is possible to perform compression to decrease the capacity of the data file while suppressing deterioration of the quality, which is an excellent effect that has not been achieved conventionally.

### BRIEF DESCRIPTION OF THE DRAWINGS

FIG. 1 is a schematic view for showing the overall constitution of the present invention;

FIG. 2 is a functional block diagram for showing the constitution of a mail server;

FIG. 3 is an illustration for describing the contents of information stored in the mail server, in which FIG. 3A shows user information and FIG. 3B shows media minimum capacity values;

FIG. 4 is a functional block diagram for showing a part of the constitution of the mail server, in which FIG. 4A shows the constitution of a primary compression processing unit and

FIG. 4B shows the constitution of a secondary compression processing unit;

FIG. 5 is an illustration for describing the state of the primary compression processing;

FIG. 6 is an illustration for describing the state of the primary compression processing;

FIG. 7 is an illustration for describing the state of the secondary compression processing;

FIG. 8 is an illustration for describing the state of the secondary compression processing;

FIG. 9 is a flowchart for showing the entire actions of the mail server;

FIG. 10 is a flowchart for showing the action of the mail server, specifically, the action at the time of primary compression processing;

FIG. 11 is a flowchart for showing the action of the mail server, specifically, the action at the time of secondary compression processing; and

FIG. 12 is a flowchart for showing the action of the mail server, specifically, a part of the action at the time of secondary compression processing.

### DETAILED DESCRIPTION OF THE PREFERRED EMBODIMENTS

The present invention is distinctive in respect that a compression threshold value indicating compression limit of data file is stored in advance for compressing the data file based on the compression threshold value. Hereinafter, embodiments are described on assumption that the data file to be compressed is a data file such as image data attached to an electronic mail, and a data compression device for compressing the electronic mail is a mail server. It is noted, however, that the data compression device, method and program according to the present invention are not limited to be used for a mail server only but used for compressing any kinds of data.

### First Embodiment

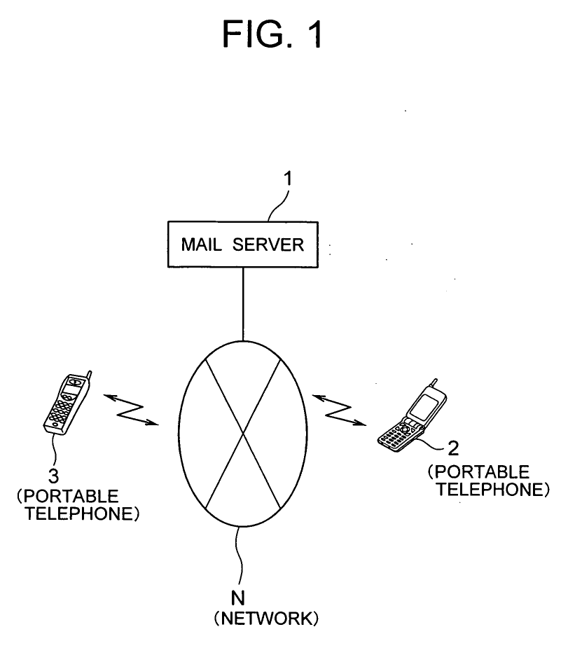

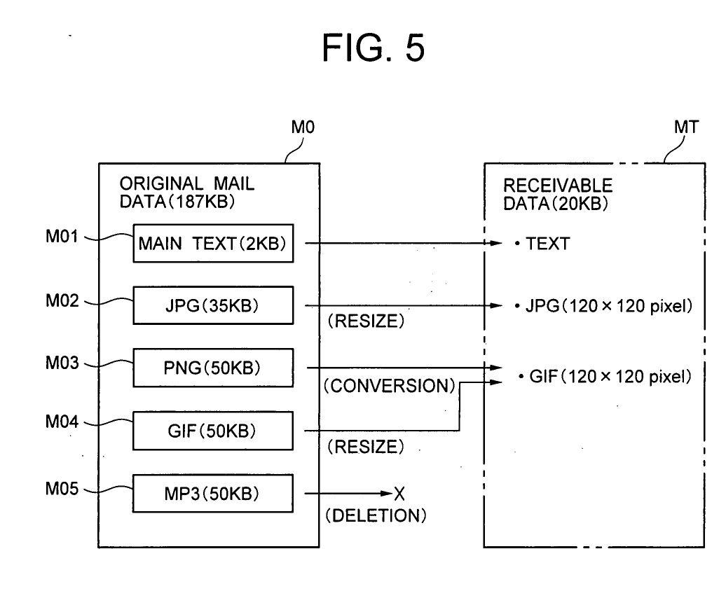

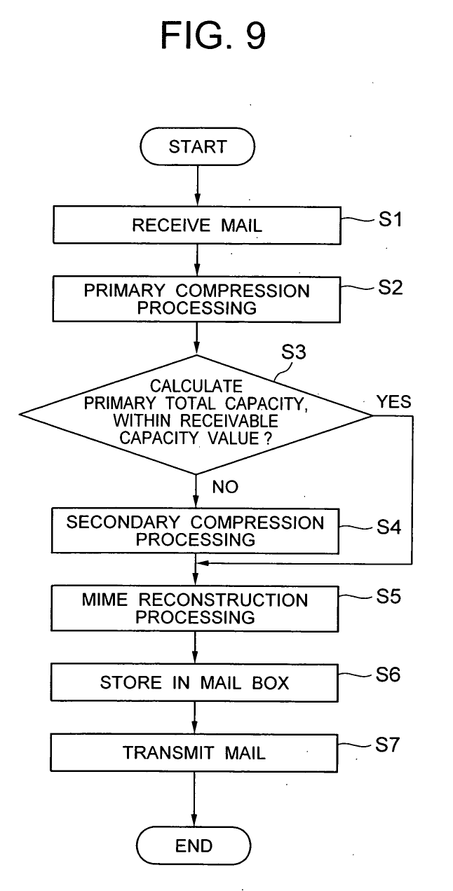

A first embodiment of the present invention will be described by referring to FIG. 1-FIG. 12. FIG. 1-FIG. 4 are illustrations for showing the constitution of the present invention, and FIG. 5-FIG. 8 are illustrations for describing the state of data compression processing. FIG. 9-FIG. 12 are flowcharts for showing the actions thereof.

(Constitution)

The data compression device according to the embodiment of the present invention is constituted with a mail server 1 that transfers an electronic mail between prescribed terminals. Thus, as shown in FIG. 1, the mail server 1 is provided on a network N between portable telephones 2 and 3 which transmit/receive electronic mails, and executes processing for compressing and transmitting the electronic mail. The mail server 1 may be constituted with a gateway provided on a portable telephone network of each communication carrier that connects each of the portable telephones 2 and 3.

Further, the portable telephones 2 and 3 are provided with a function of transmitting/receiving electronic mails with a prescribed restriction. In the embodiment, it is assumed that the portable telephone with reference numeral 2 is a transmission origin (mail transmission side) of the electronic mail, and the portable telephone with reference numeral 3 is a transmission target (mail reception side) of the electronic mail. However, the terminals transmitting/receiving the electronic mail are not limited to the portable telephones 2 and 3, but may be information processing terminals connected to a network, such as a personal computer and PDA. The mail server 1 will be described in detail hereinafter.

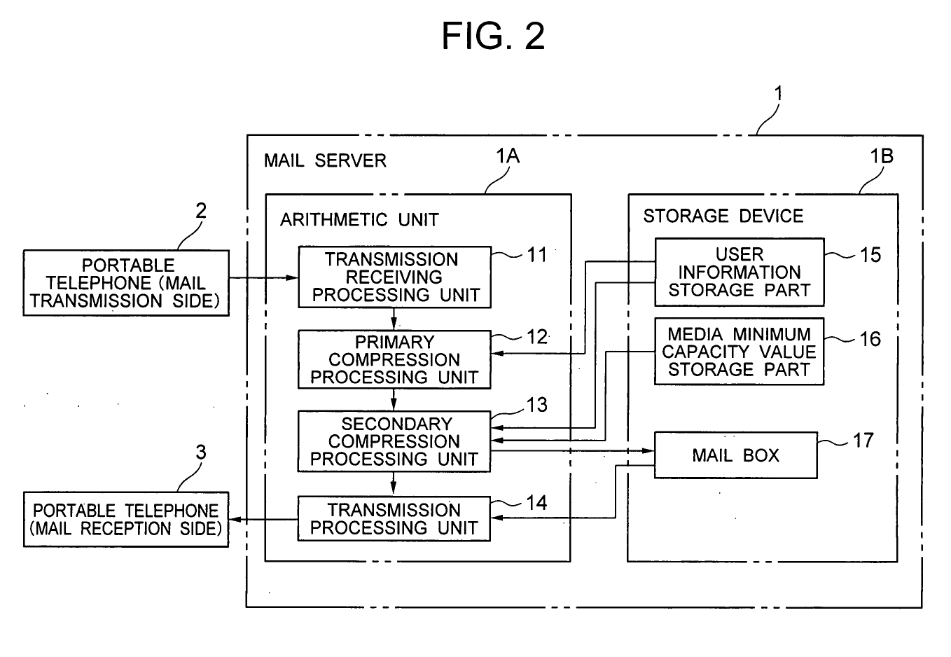

FIG. 2 shows the constitution of the mail server 1. The mail server 1 is a regular computer server which comprises an arithmetic unit 1A such as a CPU, a storage device 1B such as a hard disk, a communication function and the like. The server 1 has a normal mail-server function, i.e. receiving an electronic mail from the transmission-origin portable telephone 2, storing it in a mail box of the receiver portable telephone 3, and transmitting it to the portable telephone 3 at a prescribed timing. The mail server 1 of the embodiment specifically executes the processing for compressing the electronic mail to be transferred. In order to achieve the compression processing, the mail server 1 employs the following constitution.

A prescribed program (particularly a program for data compression) is installed in the arithmetic unit 1A of the mail server 1, and the arithmetic unit 1A is built to execute each function of a transmission receiving processing unit 11, a primary compression processing unit 12, a secondary compression processing unit 13, and a transmission processing unit 14 by executing the program. Further, the storage device 1B has areas secured for a user information storage part 15, a media minimum capacity value storage part 16, and a mail box 17. In the followings, the functions of each of the processing units 11-14 and each of the storage parts 15-17 will be described in detail.

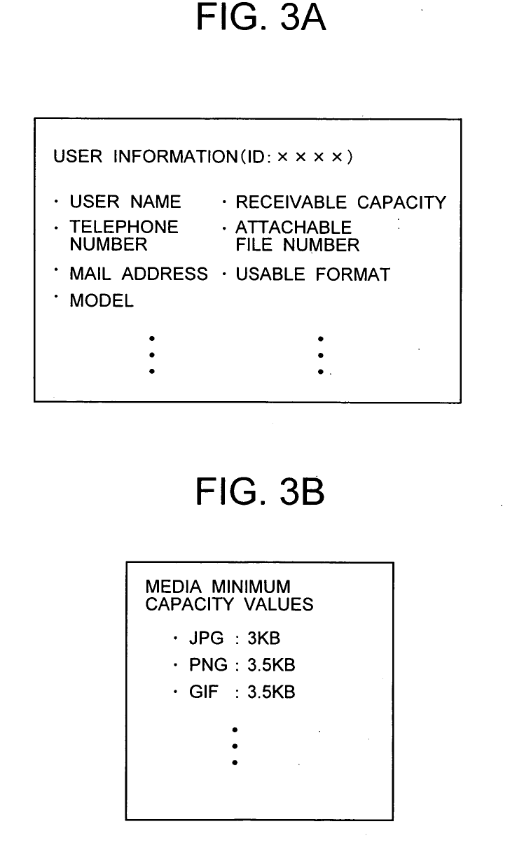

FIG. 3 shows an example of information stored in the storage device 1B. FIG. 3A is an example of user information stored in the user information storage part 15 (user information storage device). These pieces of information is registered in advance to the carrier that manages the portable telephones 2 and 3, or it may be registered by the portable telephones 2 and 3 themselves through automatically transmitting the own terminal information every time communicating with the mail server 1. The user information carries information corresponding to the portable telephones 2 and 3, such as user name, telephone number, mail address, model of the portable telephone, as well as receivable capacity, attachable file number, and usable formats. The “receivable capacity” (receiving capacity upper limit value) is an upper limit value (for example, 20 KB) of the receivable capacity per electronic mail for the respective portable telephone, for example. The “attachable file number” (number of files) is the number (for example, four) of files that can be attached to the electronic mail. The “usable format” (format information) is the information indicating the format of the data file that can be used or cannot be used by the portable telephone (for example, information such as JPG, PNG, GIF for image data). Thus, the user information storage part 15 functions as the receiving capacity upper limit value storage device, the file number storage device, and the format information storage device.

FIG. 3B shows an example of the media minimum capacity value (compression threshold value) that is stored in the media minimum capacity value storage part 16 (compression threshold value storage device). As shown in FIG. 3B, the media minimum capacity value is set for every format of the data file. FIG. 3B specifically shows the case of image data, so that there is registered the information such as “JPG format: 3 KB”, “PNG format: 3.5 KB”, “GIF format: 3.5”. These values are minimum-limit capacity values with which the quality of the image data can be maintained at a prescribed level. For example, those values are determined based on experiment or theoretical calculation. In this case, particularly, the minimum capacity value is so set that the image quality viewable by the user on the screen of the portable telephone can be maintained. However, instead of the media minimum capacity value, there may be stored the compression limit value of other property of the data file, with which the quality of the data file can be maintained at a prescribed level. For example, it may be the compression limit value of color information of the image data.

Further, the mail box 17 secured in the storage device 1B is an area for storing the electronic mails that are transmitted to each portable telephone (user). In the embodiment, the electronic mail to be transmitted to the receiver-side portable telephone 3 is stored therein. The electronic mail is outputted from the mail box 17 to the portable telephone 3 at a prescribed timing.

Next, each of the processing unit 11-14 built in the arithmetic unit 1A will be described. First, the transmission receiving processing unit 11 receives the electronic mail transmitted from the portable telephone 2 as the mail transmitter side, and gives it to the primary compression processing unit 12.

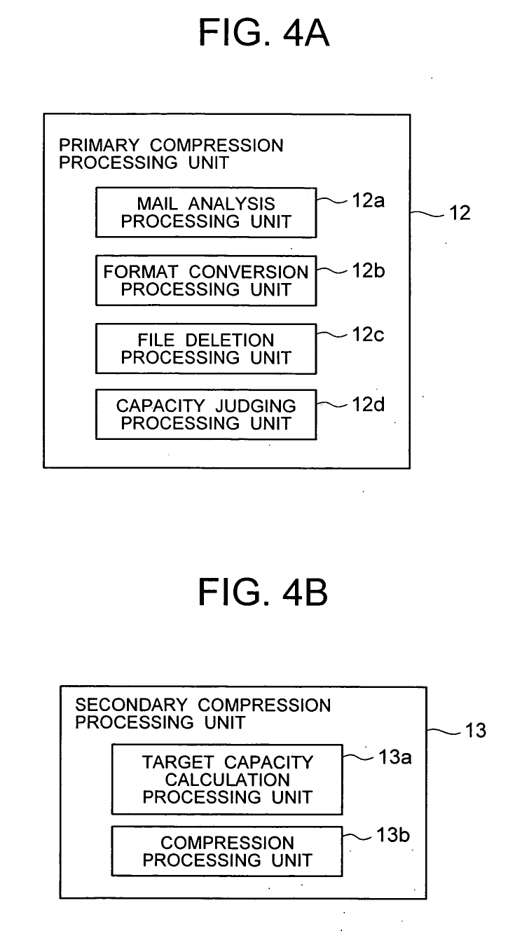

The primary compression processing unit 12 performs compression processing on the electronic mail as the transmission data in accordance with the property of the receiver portable telephone 3, e.g. deletion or conversion of the attached data. Therefore, as shown in FIG. 4A, the primary compression processing unit 12 has a mail analysis processing unit 12a, a format conversion processing unit 12b, a file deletion processing unit 12c, and a capacity judging processing unit 12d built therein.

The mail analysis processing unit 12a performs analysis processing of the electronic mail contents. Specifically, first, the mail analysis processing unit 12a specifies the receiver-side portable telephone 3 as the transmission target of the electronic mail according to the mail address or the like, and reads out the user information of the specified portable telephone 3 from the user information storage part 15. The mail analysis processing unit 12a reads out information on the property of the portable telephone 3, i.e. the receivable capacity, attachable file number, and usable format. Further, the mail analysis processing unit 12a extracts the data file attached to the electronic mail. That is, the mail analysis processing unit 12a performs processing for discriminating the text (text section) of the electronic mail and each attached file. Now, an example of the electronic mail will be described by referring to FIG. 5. As shown as original mail data (M0) on the left side of FIG. 5, the electronic mail transmitted from the transmitter-side portable telephone 2 is constituted with the main text (M01), image data of JPG (M02), PNG (M03) and GIF (M04), and music data of MP3 (M05).

The format conversion processing unit 12b (format conversion device) identifies the format that can be used by the receiver-side portable telephone 3 from the information indicating the usable format that is read out by the mail analysis processing unit 12a as described above, and judges whether or not it is possible to convert the unusable format into a usable format. When judged as possible, the format conversion processing unit 12b converts the format of the data file. An example of the processing by the format conversion processing unit 12b will be described by referring to FIG. 5. As shown in FIG. 5 on the right side, receivable data (MT) indicates the condition of the electronic mail that can be received by the receiver-side portable telephone 3 that is specified by the information readout from the user information. As described, the main text (M01) is the text data so that it can be received as it is. Further, the image data JPG (M02) and GIF (M04) can be received as well. However, the size of these image data is set as “120×120 pixels” so that it is necessary to convert the data into such size. Further, the receiver-side portable telephone 3 cannot receive (usable) the PNG (M03) image data, so that it needs to be converted into GIF format. According to this, the format conversion processing unit 12b performs processing for converting the size of the JPG (M02), GIF (M04), and processing for converting the PNG (M03) into GIF format. The above-described format does not only means the format of data structure of the data file but also includes the regulation of the size for the image data, sampling rate of the music data, etc.

The file deletion processing unit 12c (file deleting device) deletes the attached file of the format that is unusable in the receiver-side portable telephone 3. For example, in the case shown in FIG. 5, MP3 (M05) is the music data that is the information not receivable by the portable telephone 3, which cannot be converted into other usable format such as JPG. Thus, the file deletion processing unit 12c deletes that information. Further, when there are more data files attached to the electronic mail than the “attachable file number” read out from the user information, the file deletion processing unit 12c deletes a part of the attached file and limits the number of the attached files to the regulated file number. At this time, the files are deleted in order from the last attached file. Alternatively, if the user information contains priority order information according to the formats of the data files, deletion is carried out based on that information. In this case, the deletion priority order information is registered in advance to the user information storage part 15 (deletion priority order information storage device) by the user.

The capacity judging processing unit 12d calculates the total capacity of the electronic mail to which the deletion processing of the data files attached to the electronic mail has been performed in the manner as described above, and judges whether or not it falls within the range of “receivable capacity” that is contained in the user information. When the total capacity of the electronic mail is within the range of the receivable capacity, the capacity judging processing unit 12d stores the electronic mail in the mail box 17 as it is. When the total capacity of the electronic mail exceeds the above-described range, the capacity judging processing unit 12d gives the data of the electronic mail to the secondary compression processing unit 13.

Next, the secondary compression processing unit 13 will be described. The secondary compression processing unit 13 performs compression processing so that the capacity of the electronic mail processed by the primary compression processing unit 12 fits within the “receivable capacity” of the receiver-side portable telephone 3. Therefore, as shown in FIG. 4B, the secondary compression processing unit 13 has a target capacity calculation processing unit 13a and a compression processing unit 13b built therein.

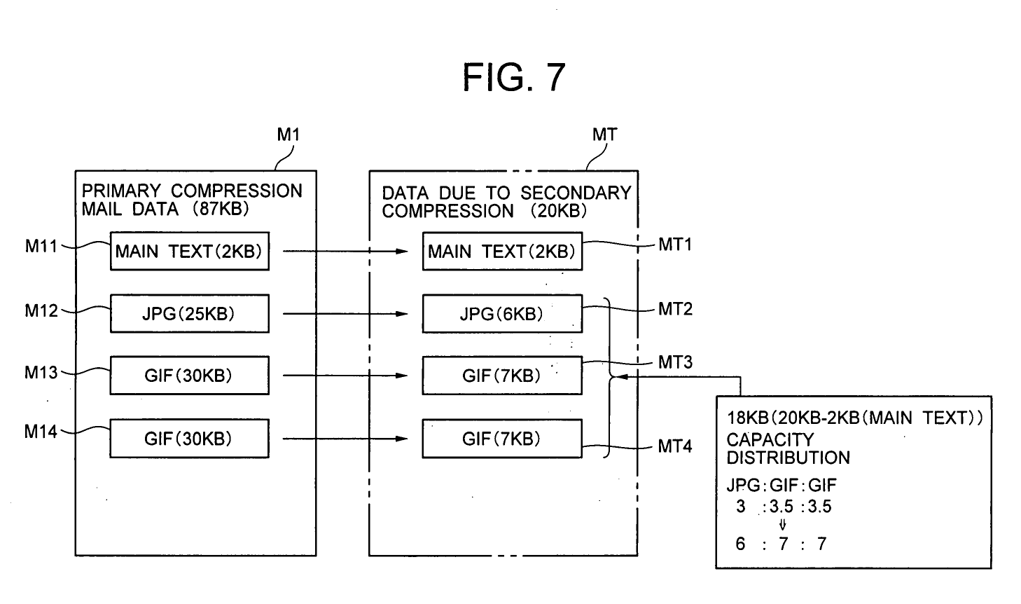

The target capacity calculation processing unit 13 (compression upper limit value allotting device) performs processing for allotting the above-described “receivable capacity” to each data file constituting the electronic mail. That is, the target capacity calculation processing unit 13 calculates how much of the capacity (target capacity) among the “receivable capacity” can be allotted to each data file (attached file) of the electronic mail. The target capacity calculation processing unit 13 treats the capacities allotted to each data file as the compression upper limit values of the respective data files. Specifically, the target capacity calculation processing unit 13 calculates the above-described compression upper limit values by allotting them to each file based on the ratio of the compression threshold values that are set in accordance with the formats of each data file. FIG. 7 shows an example thereof. In this case, as shown as the data due to the secondary compression (MT) on the right side of FIG. 7, the receivable capacity is “20 KB”. Thus, the target capacity calculation processing unit 13 allots the above-described capacity to each data file constituting the electronic mail.

At this time, it is so set in the embodiment that the mail main context (M11) is not to be compressed. Therefore, the target capacity calculation processing unit 13 subtracts the capacity of the mail main context (M11) as it is from the “receivable capacity”, and allots the remaining capacity (18 KB) to the attached files (JPG (M12), GIF (M13), GIF (M14)). It is allotted in accordance with the ratio of the minimum capacity values (compression threshold values) set for each format, which is stored in the media minimum capacity value storage part 16. Therefore, in the case of FIG. 7 where the ratio of the media minimum capacity values is JPG: GIF: GIF=3:3.5:3.5, the target capacities are JPG: GIF: GIF=6:7:7 by allotting the remaining capacity “18 KB” by that ratio. In the manner as described above, there are determined the compression upper limit values of each data file, i.e. the target capacity to be aimed at when performing the compression processing.

The compression processing unit 13b performs compression processing on each data file so that the data files fall within the target capacities determined as described above. That is, as described above, the target capacity calculation processing unit 13 determines the receivable capacities by allotting them to all the data files constituting the electronic mail. Thereby, the compression processing unit 13b compresses the electronic mail itself to fit within the “receivable capacity” (receiving capacity upper limit value). Specifically, as shown in FIG. 7, the compression processing unit 13b performs compression processing to make JPG (M12) of the primary compression mail data M1 to 6 KB or less, and GIF (M13, M14) to 7 KB or less. At this time, when the target capacity is higher than the media minimum capacity value, the compression processing unit 13 compresses the data file as the compression target to be in the capacity less than the target capacity value and larger than the media minimum capacity value. More desirably, the compression processing unit 13 repeats the compression processing so that the capacities become slightly lower than the respective target capacities, and continues compression processing until obtaining the compressed data file that is closer to the target capacity as much as possible.

The data files attached to the electronic mail are compressed by the compression processing in accordance with the media minimum capacity values that are the compression limits of the respective formats. Therefore, it is possible to achieve the compression processing by keeping the quality of the image uniform in each file. Further, the compression processing unit 13 repeatedly performs compression processing such that the capacity does not becomes less than the media minimum compression value. Therefore, it is possible to produce the compressed image data maintaining the quality level that can be viewed in the receiver-side portable telephone 3. When there is a data file that does not fit within the target capacity, the compression processing unit 13 deletes the file from the electronic mail by the above-described compression processing. Then, the compression processing unit 13b builds the electronic mail again with the data files to which the compression processing has been performed, and stores it in the mail box 17.

Further, the transmission processing unit 14 (data transmission device) transmits, to the portable telephone 3, the electronic mail addressed to the receiver-side portable telephone 3, which is stored in the mail box 17.

(Action)

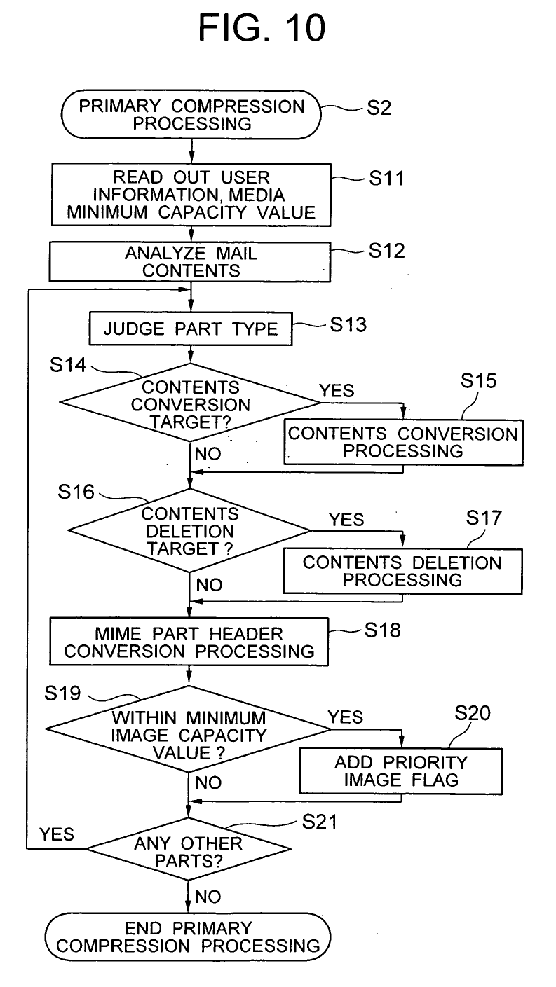

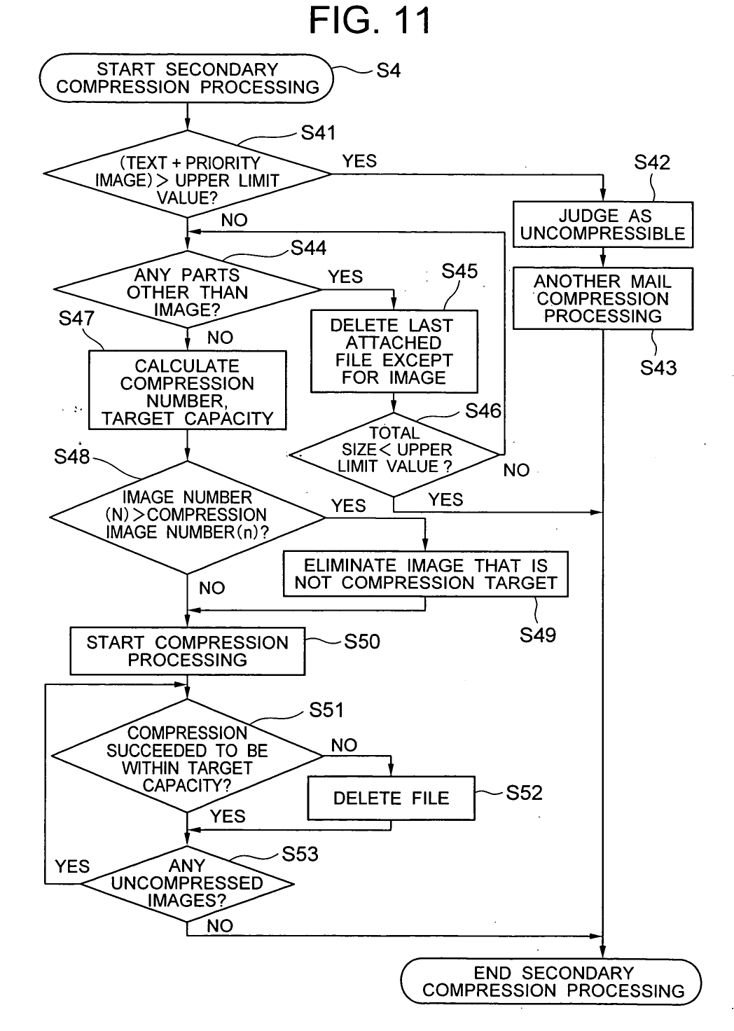

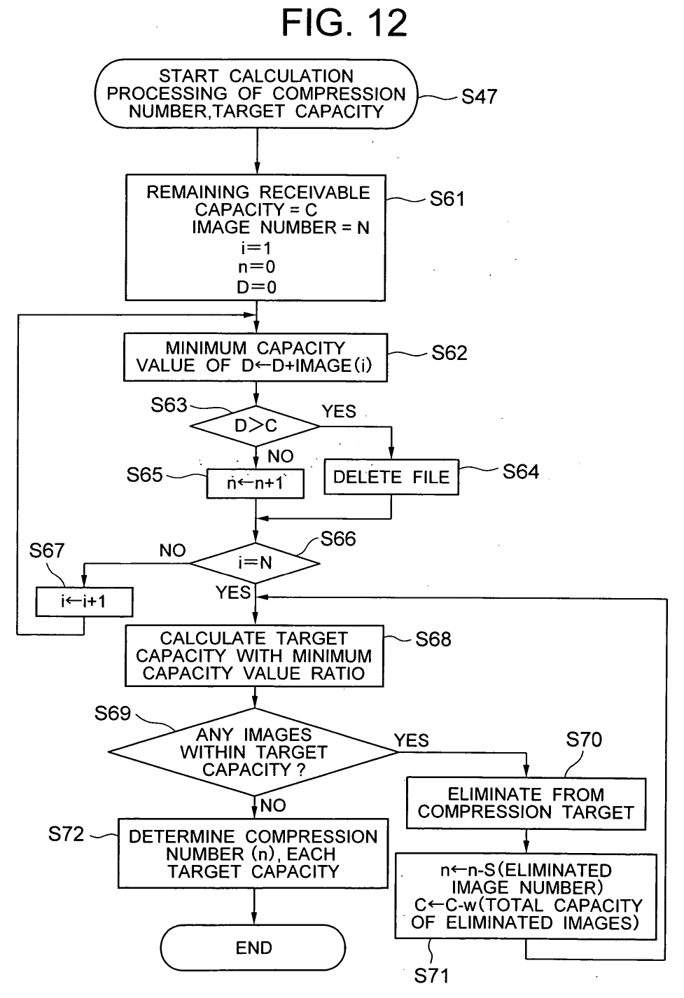

Next, actions of the mail server 1 with the above-described constitution will be described by referring to flowcharts of FIG. 9-FIG. 12. FIG. 9 is a flowchart for showing the overall action of the mail server 1. FIG. 10 shows the action of the primary compression processing, FIG. 11 is the action of the secondary compression processing, and FIG. 12 shows a part of the action of the secondary compression processing. At the same time, the state of compressing the mail data will be described by referring to FIG. 5-FIG. 8.

First, the transmitter-side portable telephone 2 forms an electronic mail for the receiver-side portable telephone 3. The contents of the electronic mail is constituted with the main text (M01) (2 KB), the image data of JPG (M02) (35 KB), PNG (M03) (50 KB), GIF (M04) (50 KB), and the music data of MP3 (M05) (50 KB) as shown as the mail data (M0) on the left side of FIG. 5, for example. The total capacity there of is 187 KB. When the electronic mail is transmitted through the network N, it is received by the mail server 1 of the receiver-side portable telephone 3 (step S1). Then, the primary compression processing is carried out by the primary compression processing unit 12 (step S2). The state of the processing will be described in detail by referring to FIG. 10.

First, the primary compression processing unit 12 of the mail server 1 specifies the receiver of the received electronic mail, i.e. the receiver-side portable telephone 3, and reads out the user information of the receiver-side portable telephone 3 from the user information storage part 15. The primary compression processing unit 12 specifically reads out the “receivable capacity”, “attachable file number”, and “usable format” of the portable telephone 3 among the user information. Further, the primary compression processing unit 12 reads out the media minimum capacity value from the media minimum capacity value storage part 16 (step S11).

Subsequently, the primary compression processing unit analyzes the contents of the electronic mail and recognizes the constitution of the mail data (step S12). That is, as shown in FIG. 5 on the left side, the primary compression processing unit 12 recognizes capacity of the main text (M01) as the text data and each capacity of the respective attached files (M01-M05). Then, the primary compression processing unit 12 executes the primary compression processing such as deletion or conversion on each of the data files (M01-M05) as will be described later. Although not shown, when the attached file number is greater than the read out “attachable file number”, the attached files are deleted in accordance with the deletion priority order information stored therewith so that it falls within the “attachable file number”.

Subsequently, the primary compression processing unit 12 pays attention to a certain data file (part) and judges the type of the file (step S13). Then, referring to the read out “usable format”, it judges whether or not the data file (contents), i.e. the attached file, is a conversion target (step S14). When it is a conversion target (Yes in step S14), the primary compression processing unit 12 performs the format conversion processing (step S15). At this time, when size of the image data is being set even if it is in the same format, the primary conversion processing unit 12 performs processing for converting the size. Furthermore, in the case where it is the data file not included in the “usable format” and not possible to be converted, it is judged as the deletion target (Yes in step S16), and the data file is deleted (step S17). Subsequently, the primary compression processing unit 12 performs conversion processing of the header of the electronic mail (step S18) according to the format conversion or deletion of the data file. Then, the primary compression processing unit 12 judges whether or not the data file (part) that is the target of the primary compression processing is less than the media minimum capacity value that is set for the format (step S19). When it is less than the minimum capacity value (Yes in step S19), the primary compression processing unit 12 adds a flag to the data file indicating that it is a priority image (step S20). This is performed to indicate that it is unnecessary to perform compression for the attached file whose capacity is already less than the media minimum capacity value. Then, the primary compression processing unit 12 repeats the above-described processing on all the data files (parts), thereby generating the primary compression mail data.

After that, the primary compression processing unit 12 calculates the total capacity of the generated primary compression mail data, and checks whether or not the total capacity has become less than the receivable capacity value (step S3). If it is not within the receivable capacity value (No in step S3), it proceeds to the secondary compression processing (step S4). If it falls within the receivable capacity value at this point (Yes in step S3), the secondary compression processing unit 13 performs MIME reconstruction processing (step S5), and stores the mail data in the mail box 17 of the portable telephone 3 as the transmittable electronic mail for the receiver-side portable telephone 3 (step S6). The transmission processing unit 14 transmits the electronic mail to the portable telephone 3 (step S7) when there is a mail acquiring request from the receiver-side portable telephone 3, or at a prescribed timing, e.g. occurrence of transmission processing event by the mail server 1.

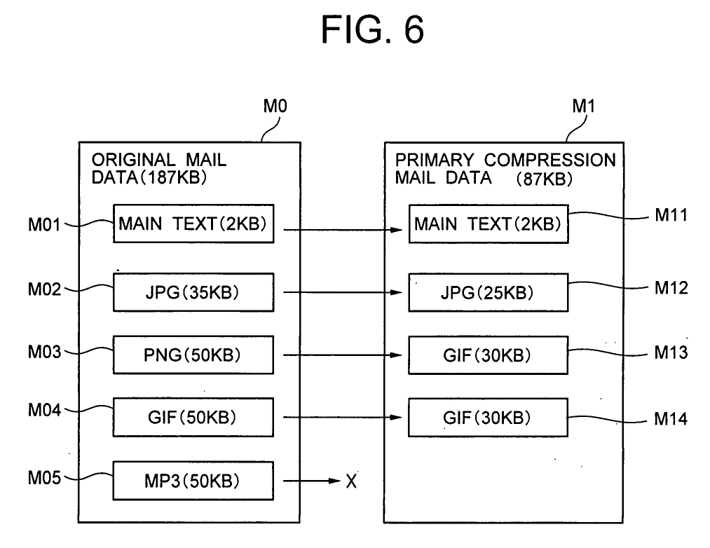

An example of the processing from the above-described step S13 to step S21 will be described by referring to FIG. 5 and FIG. 6. As described above, the left-side of FIG. 5 shows the original mail data (M0) transmitted from the transmitter-side portable telephone 3, while the right-side shows the mail data (MT) that can be received by the receiver-side portable telephone 3. The receivable mail data (MT) is set based on the read out user information. In this example, the receivable capacity is 20 KB, the usable formats are the text, JPG (120×120 pixels), and GIF (120×120 pixels). Therefore, the primary compression processing unit 12 uses, among the original mail data, the main text (M01) as it is and converts the sizes of JPG (M02) and GIF (M04) into the above-described sizes. PNG (M03) is the format not compatible with the portable telephone 3, however, it can be converted into GIF format. Thus, the primary compression processing unit 12 performs the format conversion thereon. However, MP3 (M05) is neither compatible nor convertible, so that the primary compression processing unit 12 deletes the data. Thereby, the primary compression mail data M1 is generated as in FIG. 6 on the right side. As shown in the drawing, the main text (M11) stays as 2 KB, and the JPG (M12) and the GIF (M14) are resized, thus converted to 25 KB. Further, PNG format data (M03) in the original mail data is converted into GIF format to be data (M13) of 30 KB. Thus, the total capacity of the primary compression mail data (M1) is 87 KB, which is not within the receivable capacity, 20 KB, as shown in FIG. 5. Thus, the primary compression mail data (M1) is advanced further to the secondary compression processing.

Next, the secondary compression processing (step S4) will be described in detail by referring to FIG. 11. First, the secondary compression processing unit 13 extracts, from the primary compression mail data, the main text (M11) as the text data and the image data that is the attached file, which is judged as already having the capacity less than the media minimum capacity value and provided with a priority flag, for checking whether or not the total capacity thereof is greater than the receivable capacity (20 KB) (step S41). If the total capacity of the main text and the priority image data is greater than the receivable capacity (Yes in step S41), the secondary compression processing unit 13 judges that it is impossible to compress the data to be less than the receivable capacity value even if the compression processing is continued thereafter (step S42). Since it is not possible to transmit the electronic mail in this state, the secondary compression processing unit 13 performs another compression processing (step S43). For example, it deletes the image data or deletes a part of the main text so that the total capacity of the electronic mail becomes less than the receivable capacity.

In the meantime, when the total capacity of the text and the priority image has not reached the receivable capacity (No in step S41), the secondary compression processing unit 13 judges whether or not there is a data file (part) other than the image (step S44). When there is (Yes in step S44), the secondary compression processing unit 13 deletes the last attached file except the image (step S45), and checks again whether or not the total capacity of the electronic mail becomes less than the receivable capacity value (step S46). When it is less than the receivable capacity value (Yes in step S46), the secondary compression processing unit 13 ends the compression processing. When there are no other data files than the image (no in step S44), the secondary compression processing unit 13 proceeds the processing to step S47. The above-described processing may be executed only when it is set in the mail server 1 to give priority to the image data as the attached data or it is set by the user in advance to give priority to the image data, for example. Furthermore, priority may be given to other kinds of data files.

Subsequently, in step S47, the secondary compression processing unit 13 calculates the number of the data files as the target of the secondary compression, and the compression target capacity (target capacity) for each data file. The state of the processing will be described in detail by referring to FIG. 12. First, the secondary compression processing unit 13, among the receivable capacity, calculates the remaining capacity “C” that can be allotted to the data files to be the compression target. As will be described later, the remaining capacity C is allotted to each data file to be the compression target. Further, the secondary compression processing unit 13 performs initialization of each parameter. Specifically, the secondary compression processing unit 13 sets the number of image “N” as the attached file, and the image number “i” as “i=1”. Moreover, the secondary compression processing unit 13 sets the parameters n and D as 0, respectively (step S61).

Then, the secondary compression processing unit 13 adds, to the parameter D, the media minimum capacity values that correspond to the formats of each image data (step S62). Then, the secondary compression processing unit 13 compares the total (D) of the media minimum capacity values of each image and the remaining capacity (C) of the receivable capacity every time (steps S63). If the total exceeds the remaining capacity (Yes in step S63 (D>C)), the secondary compression processing unit 13 deletes the attached image data from the electronic mail (step S64). When it is within the range of the remaining capacity (No in step S63), the secondary compression processing unit 13 adds the compression image number n (step S65). The secondary compression processing unit 13 performs such processing on all the attached image data (steps S66, S67).

After that, the secondary compression processing unit 13 calculates, based on the ratio of the media minimum capacity values, the target capacity that is the compression target capacity for the image data being judged as the compression target (step S68). FIG. 7 shows an example of such processing. As shown in this drawing on the left side, the total capacity of the mail data (MT) after the secondary compression processing is planned as 20 KB. The remaining capacity 18 KB, the result of subtracting the capacity (2 KB) of the main text (MT1) from the total capacity, is the capacity that can be allotted to the attached image data. The secondary compression processing unit 13 allots the remaining capacity to three image data (JPG (MT2), GIF (MT3), GIF (MT4)) in accordance with the ratio of the media minimum capacity values set for each format. Therefore, in the case of FIG. 7 where the ratio of the media minimum capacity values is JPG: GIF: GIF=3:3.5:3.5, the target capacities are JPG: GIF: GIF=6:7:7 when the secondary compression processing unit 13 allots the remaining capacity “18 KB” by that ratio. In the manner as described above, there are determined the target capacities (compression upper limit values) of each data file.

Then, when there is the image data having the capacity already falling within the determined target capacity (Yes in step S69), the secondary compression processing unit 13 eliminates the image data from the compression target (step S70), since the image data needs no more compression. The secondary compression processing unit 13 calculates the latest compression target number n by subtracting the eliminated image number s from the compression target number n. Further, at this time, the secondary compression processing unit 13 calculates the latest remaining capacity C by subtracting the total value w of the eliminated image capacities from the remaining capacity C (step S71). Then, the secondary compression processing unit 13 recalculates the target capacity with the latest remaining capacity C (step S68). In this way, the compression target number n and the target capacities for each image data are determined (step S72).

Subsequently, it proceeds from step S47 to step S48 of FIG. 10. The secondary compression processing unit 13 compares the number of images (N) attached to the electronic mail and the number of images (n) as the compression target (step S48). When it is N>n (Yes in step S48), the non-compression-target image is eliminated from the target of the following compression processing (step S49). Then, the secondary compression processing unit 13 performs the compression processing on each image data to be less than the target capacity values (step S50). If the target capacity value is greater than the media minimum capacity value at this stage, the secondary compression processing unit 13 repeats the compression processing so that the image data becomes less than the target capacity value and greater than the media minimum capacity value. If there is any image data that cannot be compressed to be within the target capacity (No in step S51), the secondary compression processing unit 13 deletes that file (step S52). The secondary compression processing unit 13 performs the compression processing on all the compression-target image data (step S53).

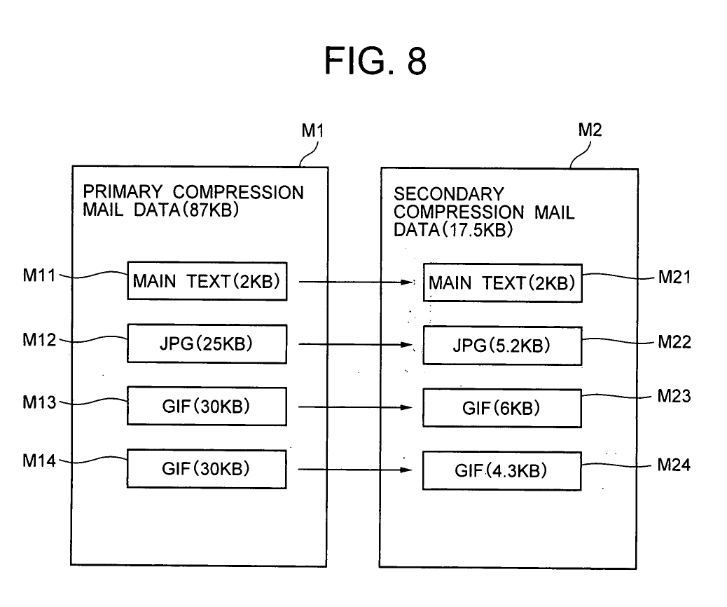

In the case of FIG. 7, the secondary compression processing unit 13 performs the compression processing so that the capacity of the JPG (M12) file changes from 25 KB to 6 KB or less and the capacities of the GIF (M13, M14) files change from 30 KB to 7 KB or less, respectively. Specifically, the secondary compression processing unit 13 repeats the compression processing so that the capacities become slightly lower than the respective target capacities, and continues compression processing until obtaining the compressed data file that is closer to the target capacity as much as possible, which in this case means to perform the compression processing not to be less than or equal to the media minimum capacity value. The compression processing on each image data can be performed in parallel. By way of example, it is assumed as shown in FIG. 8 on the right side that the capacity of JPG (M12) is compressed to 5.2 KB, GIF (M13) to 6 KB, and the other GIF (M14) to 4.3 KB. With this, all the image data fit within the target capacity and the total capacity of the second compression mail data (M2) is 17.5 KB, which is lower than the receivable capacity, 20 KB. As described above, when there is the image data not fitted within the target capacity, that image data is deleted. Thus, the final secondary compression mail data is to be fitted within the receivable capacity. Furthermore, all the image data exceed the respective media minimum compression capacity values, thereby suppressing deterioration of the picture-qualities.

After that, the secondary compression processing unit 13 performs MIME reconstruction processing as described above (step S5), and stores it in the mail box 17 of the portable telephone 3 as the transmittable electronic mail for the receiver-side portable telephone 3 (step S6). The transmission processing unit 14 transmits the electronic mail to the portable telephone 3 (step S7) when there is a mail acquiring request from the receiver-side portable telephone 3 or at a prescribed timing, e.g. transmission processing from the mail server 1.

In the manner as described above, the transmitted electronic mail satisfies the capacity condition for being receivable by the receiver-side portable telephone 3, and only the image data of viewable format is attached thereto. Therefore, the electronic mail can be surely viewed in the receiver-side portable telephone 3. Each image data as the attached file is compressed in accordance with the media minimum capacity value, i.e. the compression limit of the each image format. Thus, excessive compression processing can be suppressed so that the images with less picture-quality deterioration can be obtained. Furthermore, the picture qualities of a plurality of the files can be kept almost uniform.

The mail server 1 performing such processing calculates in advance the compression target capacities of each data file of the compression target, and performs the compression processing aiming at the capacities. Thus, the compression processing for each data file can be performed in parallel. Thereby, it is possible to suppress repeated execution of the compression processing on the entire electronic mail to be performed until the capacity fits within the receivable capacity value. As a result, speed of the processing can be increased and the processing load can be reduced.

The data compression device of the present invention can be utilized as a mail server for executing the compression processing on electronic mails, thus exhibiting industrial applicability.

What is claimed is:

1. A data compression device, comprising:
a storage device for storing a compression threshold value indicating compression limit that is set in accordance with a property of a data file; and
a compression device for compressing the data file based on the compression threshold value.

2. The data compression device as claimed in claim 1, wherein the compression device compresses the data file such that the property does not become less than the compression threshold value.

3. The data compression device as claimed in claim 1, wherein the compression threshold value is at least a value that is set for maintaining quality of the data file, a value that is set for maintaining picture quality of the data file, or a value that is set in accordance with a capacity value of the data file.

4. The data compression device as claimed in claim 1, wherein:
the compression threshold value is a value set for each format of the data file; and
the compression device performs compression on the data file in accordance with the compression threshold value that is set for same format as the format of the data file.

5. The data compression device as claimed in claim 1, comprising a data transmission device for transmitting the data file as transmission data, which is compressed by the compression device, to a terminal connected through a network.

6. The data compression device as claimed in claim 3, wherein:
the compression threshold value includes a receiving capacity upper limit value of a terminal as a transmission target of transmission data; and
the compression device performs compression such that capacity of the transmission data fits within the receiving capacity upper limit value.

7. The data compression device as claimed in claim 6, wherein:
the transmission data contains a plurality of the data files;
the storage device has a function of allotting the receiving capacity upper limit value as compression upper limit values for each data file; and
the compression device performs compression such that the capacities of the respective data files become lower than the allotted compression upper limit values.

8. The data compression device as claimed in claim 7, wherein the storage device allots the compression upper limit value in accordance with the compression threshold values that are set according to the formats of the respective data files.

9. The data compression device as claimed in claim 8, wherein the storage device allots the compression upper limit values in accordance with ratio of each compression threshold value of each format of the respective data files.

10. The data compression device as claimed in claim 8, wherein:
the storage device stores format information indicating usable or unusable format for the terminal as the transmission target of the transmission data; and
the compression device deletes the data file of the unusable format based on the format information in the storage device.

11. The data compression device as claimed in claim 8, wherein:
the storage device stores format information indicating usable or unusable format for the terminal as the transmission target of the transmission data; and
the compression device converts the data file of the unusable format into the usable format based on the format information in the storage device.

12. The data compression device as claimed in claim 1, wherein:
the storage device stores number of files that can be received in a terminal as a transmission target of transmission data; and
the compression device deletes a prescribed data file from the transmission data so that data file number contained in the transmission data falls within the file number stored in the storage device.

13. The data compression device as claimed in claim 1, wherein:
the storage device stores pre-set deletion priority order information of the data files; and
the compression device deletes the data file based on the deletion priority order information.

14. A data compression program for allowing a computer, which constitutes a data compression device for compressing a data file, to execute functions of:
storing a compression threshold value indicating compression limit that is set in accordance with property of the data file; and
compressing the data file in accordance with the compression threshold value.

15. A data compression method, comprising the steps of:
a storing step for storing a compression threshold value indicating compression limit that is set in accordance with property of the data file; and
a compression step for compressing the data file in accordance with the compression threshold value.
